(19) United States
(12) Patent Application Publication
(10) Pub. No.: US 2008/0107466 A1
(43) Pub. Date: May 8, 2008

(54) Printing Apparatus

(76) Inventor: James T. Craig, Newtown, CT (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/589,523

(22) PCT Filed: Feb. 18, 2005
(86) PCT No.: PCT/IB05/00641

§ 371 Date: Sep. 14, 2007

(30) Foreign Application Priority Data
Feb. 20, 2004 (GB) 0403827.9

(51) Int. Cl. B41J 11/00; G06K 19/06

(52) U.S. Cl. 400/582; 235/494

(57) ABSTRACT

A printer for printing an image on an image receiving material provided on a backing material, the backing material having regularly spaced markings provided on the back thereof, said printer including a detector for detecting said markings, and a device for determining at least one of a spacing between two markings and a width of a marking, comparing the determined marking width and/or spacing with a respective reference value and for causing printing to be stopped if at least one of the determined spacing and/or width differs from the respective reference value by more than a predetermined amount.

### BACKGROUND OF THE INVENTION

1. Field of the Invention

The invention relates to a printing apparatus and, in particular, to a printing apparatus which is arranged to print an image on a discrete label or a continuous supply of tape. The invention also relates to a supply of labels and to a supply of image receiving tape.

2. Related Technology

Printers are known which are arranged to print an image on a continuous supply of tape or on discrete labels held on a continuous backing layer.

It has been proposed to place markings on the back of the continuous backing medium or the backing layer of a continuous tape. For example, in EP 575 772 a thermal printer is disclosed on which an image is printed on discrete labels. Markings to identify the characteristics of the label can be provided either on the label itself or on the backing sheet. The markings are read by the thermal printer and are used to determine whether an image should be printed directly on the label by the thermal printer or whether an ink ribbon is required to print an image thereon.

U.S. Pat. No. 4,531,851 describes a printer which prints an image on a plurality of discrete labels carrying the backing web. Each label on the backing web has a marking which is used to control the timing of a printing. In other words, the signal resulting from the detection of the marks on each label is used to control when the printer is activated so that the image falls within the label boundaries.

EP 934 168 (Esselte N.V.) discloses a tape printing apparatus where markings are provided on the back of the tape. These markings are used for example to indicate the characteristics of the tape such as colour, tape width, whether or not an ink ribbon is required etc. In this document, the speed of the tape is determined from the markings and this in turn is used to control the speed of a motor to hold the speed constant. The information is also used to control the strobing of the print head in response to the speed.

JP 2000-318249 discloses a printer for an automatic cash delivery machine having a compensation unit which corrects a print start position by comparing actual and set mark detection times.

### SUMMARY OF THE INVENTION

According to a first aspect, the invention provides a printer for printing an image on an image receiving material provided on a backing material, said backing material having regularly spaced markings provided on the back thereof, said printer comprising means for detecting said markings and means for determining at least one of a spacing between two markings and a width of a marking, comparing the determined marking width and/or spacing with a respective reference value and for causing printing to be stopped if at least one of the determined spacing and/or width differs from the respective reference value by more than a predetermined amount.

According to a second aspect, the invention provides an image receiving material provided on a backing material with regularly spaced markings provided on the back of the backing material for use in a printer comprising means for detecting said markings, means for determining at least one of a spacing between two markings and a width of a marking, comparing the determined marking width and/or spacing with a respective reference value and for causing printing to be stopped if at least one of the determined spacing and/or width differs from the respective reference value by more than a predetermined amount.

According to a third aspect, the invention provides a printer system for printing an image on an image receiving material provided on a backing material, said backing material having regularly spaced markings provided on the back thereof, said printer system comprising means for detecting said markings and means for determining at least one of a spacing between two markings and a width of a marking, comparing the determined marking width and/or spacing with a respective reference value and for causing printing to be stopped if at least one of the determined spacing and/or width differs from the respective reference value by more than a predetermined amount.

According to one embodiment, the invention provides a printer for printing an image on a image receiving material provided on a backing material, said backing material having regularly spaced markings provided on the back thereof, said printer comprising means for detecting said markings and means for sending information relating to said detected marking to a computer for processing.

### BRIEF DESCRIPTION OF THE DRAWINGS

For a better understanding of the invention and as to how the same may be carried into effect, reference will now be made by way of example only to the accompanying drawings in which:

FIG. 1 shows two die cut labels on a backing material embodying the invention;

FIG. 2 shows a schematic view of a printer embodying the invention;

FIG. 3 shows a flow chart illustrating the method of the invention; and

FIG. 4 shows the output of a phototransistor of the arrangement of FIG. 2.

### DETAILED DESCRIPTION

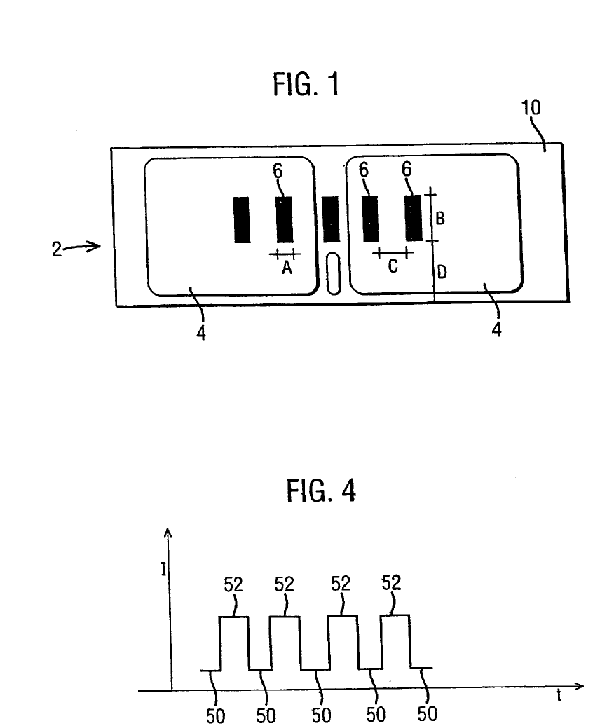

Reference will first be made to FIG. 1 which shows two labels 4 on a backing material 2 defining a label supply 10. The labels 4 are discrete labels i.e. die cut labels. The labels 4 are adhered to the backing material 2. The backing material 2 has a release coating on the side to which the labels are adhered in order to allow the labels to be easily removed from the backing material once a label has been printed. Markings 6 are provided on the side of the backing material 2 opposite to that on which the labels 4 are provided. For schematic purposes, FIG. 1 shows the labels and markings apparently on the same side as the backing tape. This might occur in embodiments where the markings are invisible to the naked eye. However, in preferred embodiments of the invention, the markings are on the other side of the backing material 2 to the labels.

The markings each have the same width A and the same separation distance C. The height of the markings is indicated by B and the distance between the edge of the backing material and the start of a marking, as measured across the width of the backing material is D. By way of example only, A may be 3 mm, B may be 8 mm, C maybe 8 mm and D may be 11.5 mm. However, these measurements are given by way of example only and the size of the measurements may vary.

The markings may extend continuously along the length of the backing material or may be provided in clusters at regular intervals. For example, N markings equally spaced apart from one another may constitute a set of markings. There may be M sets of N markings with the sets of markings being separated by a distance which is greater than the separation of the markings within a set.

The size of the markings and/or the distance therebetween may be altered to reflect different label sizes and/or materials.

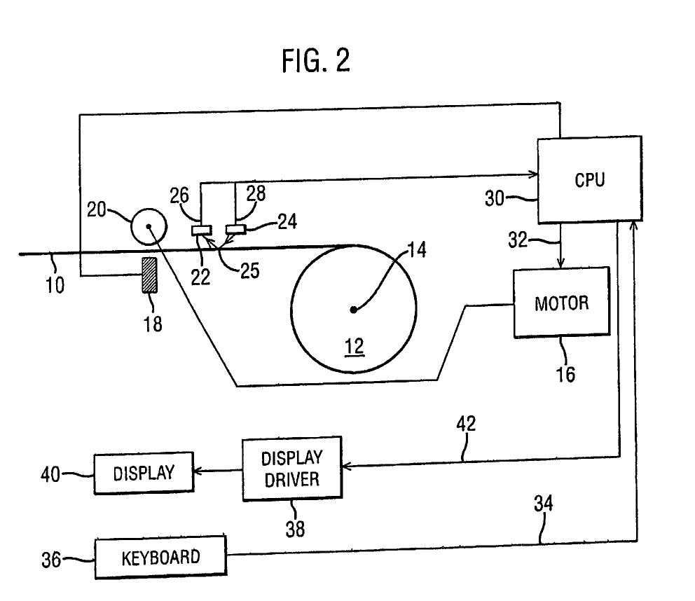

Reference is now made to FIG. 2 which shows a schematic view of a printer embodying the invention.

The label supply 10 is provided on a supply reel 12. In alternative embodiments of the invention, the label supply may be provided in a cassette. In other embodiments of the invention, the label supply is provided as a fan-fold stack.

The supply reel 12 is mounted on a spindle 14 about which the supply reel can rotate.

A print head 18 is provided for printing on the die cut labels 4. The print head 18 is controlled in accordance with data provided from a CPU (Central Processing Unit) 30 or any other suitable processing element or print head driver.

The image printed on the tape may be input by the user via a keyboard 36. The keyboard 36 is connected to the CPU 30. The CPU processes the input data from the keyboard and puts it into a format suitable for controlling the print head 18.

The print head 18 acts against a platen 20. In this embodiment, the platen 20 is rotatably driven by a motor 16. The print head and/or the platen may be movable apart from one another to allow the easy insertion of the material between the platen and the printer head. During printing, the platen 20 and print head 18 will be urged one against the other. When the print head 18 and platen 20 are in the printing configuration, rotation of the platen 20 will cause image receiving material to be pulled from the supply roll 12.

The motor 16 may be controlled in embodiments of the invention by the CPU 30 via an input line 32.

Embodiments of the invention are provided with a sensor arrangement 25. The sensor arrangement 25 comprises a light source 24 which may be a light emitting diode and a light detector 22 which may be in the form of a phototransistor. The phototransistor 22 is arranged to detect light emitted by the light source 24 which is reflected from the rear surface of the image receiving medium i.e. the surface on which the markings are provided. In embodiments of the invention the markings are darker than the background of the image receiving tape. Thus, more light is reflected from the regions between the markings to the photo transistor than when the light from the light emitting diode 24 impinges a marking.

In some embodiments of the invention a grating may be provided between the light emitting diode and photo transistor on the one hand and the backing material on the other hand. The grating is there to improve the quality of the wave form provided by the photo transistor 22. The width of the slit of the grating is selected to have a width generally corresponding to the width of a single line. The provision of the grating can improve the contrast between the light regions and the dark regions. This in turn may provide sharper peaks and troughs in the wave form provided by the photo transistor.

The output of the photo transistor 22 is input via a line 26 to the CPU. The CPU 30 may control the light emitting diode 24 via line 28.

The apparatus also comprises a display 40 which is controlled by the output of the CPU 30 via a line 42. In particular, the output of the CPU 30 is input to a display driver 38 which controls the information displayed on the display 40.

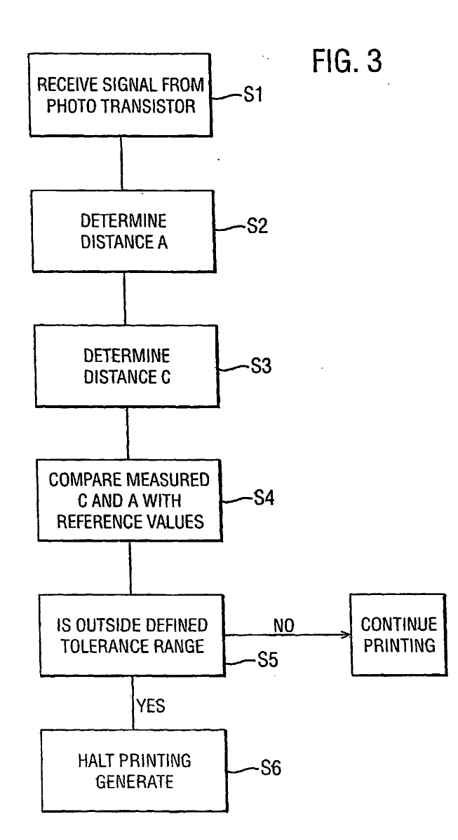

Reference will now be made to FIG. 3 which shows a flow chart illustrating the steps of the invention in conjunction with FIG. 4 which shows the output of the photo transistor 22. In particular, FIG. 4 shows the wave form produced with intensity on the y axis and time on the x axis. As can be seen, there are regular troughs 50 with a low intensity. These correspond to the detection of the dark areas. These are separated by peaks 52 which are representative of the light areas. In practice, the wave form may be more sinusoidal. This may be processed or analysed to give the same results obtainable from the waveform of FIG. 3 using for example threshold values.

Reference is now made to FIG. 3 which shows a flow chart of a method embodying the invention.

In step S1, the CPU receives the signal from the photo transistor 26.

In step S2, the CPU 30 analysis the received signal, in particular, the CPU is arranged to determine distance A, that is the width of the line. This is done by measuring the time for which a given trough is detected. It is assumed that the platen is rotating at a given speed x. Multiplication of the assumed speed of the platen by the time will give the distance A.

In step S3, the distance C is determined. This is determined in a similar manner to the distance A but instead the length of time for which a given peak exists is multiplied by the assumed speed to give the distance C.

In step S4, the measured values for A and C are compared to reference values indicating the actual values for those components, if the platen is rotating at speed x.

In step S5, it is determined whether the difference between the measured value of A and the actual value of A is in a predefined tolerance range. It is also determined whether the difference between the measured value for C and the actual value of C is also within a defined tolerance range. If the values are within the defined tolerance range, then the printing operation continues as normal. If it is determined that the values of C and/or A measured fall outside a defined tolerance range, then the printing is halted. An error message is optionally generated and this may be displayed on the display. The tolerance range may for example be plus or minus 20% of the actual values. To avoid anomalous results, printing is only stopped if the values of A and/or C are outside the defined tolerance range for Y consecutive marks and intervals. For example Y may be in the region of 3. However, this is again a matter of design choice which takes into account the size of the markings, the sensitivity of the detection equipment and the like.

If the measurement is outside the defined tolerance range, this means that the speed which has been assumed for the speed on which the tape moves past the print head is not correct. This may for example be due to a label supply jam, motor malfunction, end of the supply or the like.

In the preferred embodiment of the invention, dark markings against a light back ground are used. In alternative embodiments light markings against a dark background can be used. Highly reflective markings can be used. Markings which are not visible may be used such as for example magnetic markings.

In one embodiment of the invention, a stand alone tape printer may be used. The stand alone printer would have the elements shown in FIG. 2. In another embodiment of the invention a printer embodying the invention may be connected to a PC. In such a printer the display, display driver and keyboard functions would be provided by the P.C. At least part of the CPU function may be provided by a CPU of the PC.

The detection of the markings would take place in the printer. The processing of the results of the detection may take place in either a CPU of the printer or a CPU of the PC or a combination of a processing capability in the printer and the PC.

The printer may be connected to the PC via a cable or wireless connection.

Reference is made to reference values in this specification. It should be appreciated that a plurality of reference values may be used to define a range and if a value falls outside the range, printing is stopped.

Where the labels are die cut labels a registration mark or a hole may be provided on or through the backing layer at a location between the two labels. The mark or hole may comprise two or more marks or hole extending along a line parallel to the width of the backing layer. This hole or mark is detected using the arrangement shown and/or an additionally arrangement. Thus the printer is able to identify the beginning of a label and control the printing accordingly.

1. A printer for printing an image on an image receiving material provided on a backing material, said backing material having regularly spaced markings provided on the back thereof, said printer comprising:
a detector for detecting said markings; and
a device for determining at least one of a spacing between two markings and a width of a marking, comparing the determined marking width and/or spacing with a respective reference value and for causing printing to be stopped if at least one of the determined spacing and/or width differs from the respective reference value by more than a predetermined amount.

2. A printer as claimed in claim 1 wherein said detector comprises at least one of a light sensitive receiver and a light source.

3. A printer as claimed in claim 2, wherein said light sensitive receiver comprises a light emitting diode.

4. A printer as claimed in claim 2, wherein said light source comprises a light emitting diode.

5. A printer as claimed in claim 1, wherein said determining device comprises a processor.

6. A printer as claimed in claim 1, wherein printing is stopped if the determined spacing differs from the respective reference value by 20% or more.

7. A printer as claimed in claim 1, wherein said determining device is arranged to cause an error message to be displayed if printing is stopped.

8. A printer as claimed in claim 1 in combination with a PC.

9. A printer as claimed in claim 1, where said reference value comprises a plurality of values defining a range.

10. In combination, a printer as claimed in claim 1 and an image receiving material provided on a backing material with regularly spaced markings provided on the back of the backing material.

11. A combination as claimed in claim 10, wherein said image receiving material comprises one of continuous tape and die cut labels.

12. An image receiving material provided on a backing material with regularly spaced markings provided on the back of the backing material for use in a printer comprising a detector for detecting said markings, device for determining at least one of a spacing between two markings and a width of a marking, comparing the determined marking width and/or spacing with a respective reference value and for causing printing to be stopped if at least one of the determined spacing and/or width differs from the respective reference value by more than a predetermined amount.

13. A printer system for printing an image on an image receiving material provided on a backing material, said backing material having regularly spaced markings provided on the back thereof, said printer system comprising:
a detector for detecting said markings; and
a device for determining at least one of a spacing between two markings and a width of a marking, comparing the determined marking width and/or spacing with a respective reference value and for causing printing to be stopped if at least one of the determined spacing and/or width differs from the respective reference value by more than a predetermined amount.

14. A printer system as claimed in claim 13 comprising a printer and a PC.

15. A printer for printing an image on a image receiving material provided on a backing material, said backing material having regularly spaced markings provided on the back thereof, said printer comprising:
a detector for detecting said markings; and
a transmitter for sending information relating to said detected marking to a computer for processing.

16. An image receiving material comprising a backing layer, said backing layer having on one side there of an image receiving layer comprising one of continuous material and die cut labels, and on the other side of the backing layer, regularly spaced markings being provided, said regularly spaced markings being, in use, used to stop printing of a printer if the detected marking width and/or marking spacing differs from a respective reference value by more than a predetermined amount.
